(19) United States
(12) Patent Application Publication
(10) Pub. No.: US 2026/0232405 A1
(43) Pub. Date: Aug. 13, 2026

(54) JAW DISPLACEMENT SYSTEM TO INFLUENCE THE GROWTH OF THE LOWER JAW

(71) Applicant: MANDIBLE GUIDE B.V., Sint-Pieters-Woluwe (BE)

(72) Inventors: Hugo DE CLERCK, Tervuren (BE); Hildegarde TIMMERMAN, Tervuren (BE)

(21) Appl. No.: 19/155,011

(22) PCT Filed: Feb. 9, 2024
(86) PCT No.: PCT/IB2024/051250

§ 371 Date: Aug. 8, 2025

(30) Foreign Application Priority Data
Feb. 9, 2023 (BE) BE2023/5096
Feb. 10, 2023 (BE) BE2023/5100

(51) Int. Cl. A61C 7/10; A61C 7/36

(52) U.S. Cl. CPC A61C 7/10; A61C 7/36; A61C 2201/00

(57) ABSTRACT

A jaw displacement system for moving a lower jaw (5) relative to an upper jaw (6), comprising:-at least one bone anchor (7),—an elongated jaw displacer (8),—a frame (9), wherein the jaw displacer (8) allows to apply a pressure force between the frame (9) and the bone anchor (7), so as to ventrally move the lower jaw (5) relative to the upper jaw (6) when the frame (9) is fixed to said molars (19) and when the bone anchor (7) is fixed to the bone of the lower jaw (5) on the vestibular side.

WO

The invention relates to a jaw displacement system for moving a lower jaw relative to an upper jaw. This system is provided with at least one bone anchor comprising a fixation plate for fixing the bone anchor to the bone of the lower jaw. This fixation plate is connected to a connecting element that leads to a mounting member. When the bone anchor is attached to the bone, the connecting element should protrude through the gums so that the mounting member is located in the oral cavity.

Furthermore, the jaw displacement system includes an elongated jaw displacer with two opposite ends. The jaw displacer allows a pressure force to be exerted between its ends and it can be attached to the mounting member with one of these ends. The jaw displacer is thus provided to be attached with one end to the mounting member in the oral cavity.

The jaw displacement system according to the invention is particularly suitable as a medical device for influencing lower jaw growth and occlusion in patients with class II occlusion, also called disto-occlusion. In such patients, the teeth of the upper jaw are positioned too far forward compared to the teeth in the lower jaw. In most cases, this is caused by underdevelopment of the lower jaw and/or excessive growth of the upper jaw, leading to a convex profile of the face.

Patients with class II malocclusion usually have an underdeveloped lower jaw, causing the dental arch of the lower jaw to be positioned too far back in relation to the dental arch of the upper jaw. This increases the distance between the upper and lower incisors. This can lead to one or more of the following complications:
palatal bite of the lower incisors,
outgrowth of the lower and upper incisors,
functional problems such as teeth grinding and pathology of the temporo-mandibular joint, and
disruption of facial aesthetics due to an underdeveloped chin and a convex soft tissue profile.
   Further, a lower jaw that is receding relative to the upper jaw can also lead to sleep

There are currently several treatments for patients with class II malocclusion. In young patients, attempts are made to stimulate the growth of the lower jaw. Moving the lower jaw into a forward position over an extended period of time can cause growth changes in the jaw joints and in the jaw angle (gonial angle), resulting in a permanent forward displacement of the chin. This forward displacement of the lower jaw can be achieved by using removable or bonded orthodontic braces, also called orthopaedic braces because they attempt to alter the growth of the jaw. The disadvantage of using such braces is that they rest on the teeth, which causes unwanted tooth movements. Forward movements of the lower incisors are particularly undesirable. When using such braces that rest on the teeth, the unwanted tooth movements are ultimately much greater than the intended growth changes of the jaw.

In patients with class II malocclusion, if the growth of the lower jaw cannot be sufficiently stimulated, or if growth has ceased, the lower jaw can only be moved forward by performing jaw surgery, especially an osteotomy.

One of the orthopaedic devices used today for the correction of class II malocclusion is the so-called Herbst device. The Herbst device has two telescopic joints extending along either side of the dental arch and which are connected to a frame attached to the teeth of the upper jaw and a frame attached to the teeth of the lower jaw. This device thus ensures that the teeth of the lower jaw and the lower jaw itself are pushed forward relative to the upper jaw as soon as the patient closes his/her mouth. However, due to the dental anchorage of the Herbst device, it mainly causes the teeth to move and only to a limited extent a change of growth in the lower jaw. The premolars and incisors of the lower jaw are moved forward here, with these lower incisors also tilting forward. This in turn leads to occlusion problems, periodontal problems, and bone loss at the roots of the lower incisors.

For example, documents US 2014/0272759 and U.S. Pat. No. 4,462,800 describe such use of a Herbst device.

The telescopic joint of the Herbst device is usually attached between a hinge provided on the upper first molar and a hinge attached to the lower first premolar. If the longitudinal axis, more specifically the direction of the applied force, of the telescopic joint is excessively inclined with respect to the occlusal plane and extends above the jaw joint, it will result in a posterior rotation of the lower jaw. This increases the facial height and moves the chin backwards.

In order to remedy these disadvantages, mini-implants are sometimes used as an alternative to the dental anchorage of the Herbst device to transfer the pressure force of the Herbst device directly to the jaw's bone. Such systems are described, for example, in documents US 2006/0172251, WO 2009/085321 or WO 2010/037195. However, the use of these mini-implants results in the orientation of the Herbst device deviating too much from the direction of the occlusal plane because the mini-implants must be attached to the jaw's bone at a sufficient distance from the teeth's roots to avoid damage to the dental roots. As already mentioned, such an orientation of the Herbst device causes posterior rotation of the lower jaw and does not sufficiently stimulate the forward growth of the jaw in the ventral direction. In addition, mini-implants are less suitable for absorbing the relatively large force application associated with the use of a Herbst device and therefore frequently fail.

Furthermore, such treatments often result in a so-called crossbite as a consequence of moving the lower jaw forward relative to the upper jaw. As a result, the widest part of the dental arch of the lower jaw is positioned opposite a narrower part of the dental arch of the upper jaw, which causes a crossbite.

The invention aims to remedy the above disadvantages by proposing a jaw displacement system with a jaw displacer that allows the lower jaw to be moved ventrally with respect to the upper jaw without directly exerting a pressure force on the teeth of the lower jaw. This ensures that the orientation of the jaw displacer, in particular the direction in which the jaw displacer exerts a pressure force, approximates the orientation of the occlusal plane as much as possible. Furthermore, the jaw displacement system also allows relatively large forces to be absorbed, even in young patients whose upper jawbone and/or lower jawbone has not yet fully grown, for example.

To this aim, the jaw displacement system comprises a frame that allows molars of the same quadrant of the upper jaw to be rigidly connected to each other, the frame comprising a connecting element for one of the ends of said jaw displacer. When the frame is fixed to the molars and when the bone anchor is fixed to the lower jaw's bone on the vestibular side, the jaw displacement system according to the invention will allow said ends of the jaw displacer to be connected with said mounting member and said connecting element, respectively, in order to exert a pressure force between the bone anchor and the frame to move the lower jaw in the ventral direction with respect to the upper jaw.

Said frame preferably forms a rigid whole.

Preferably, said connecting element is provided to the frame at a position distal to the first molar when a frame is attached to said molars.

According to an interesting embodiment of the jaw displacement system according to the invention, said frame is provided for each of the two quadrants of the upper jaw, wherein these two frames may possibly be rigidly connected to each other.

According to a preferred embodiment of the invention, said jaw displacement system comprises a rod and a rod guide, wherein the rod connects to one of said ends of the jaw displacer and wherein the rod guide connects to the opposite end of the jaw displacer, such that the rod can be moved in the longitudinal direction of the rod guide relative to the latter.

According to a particularly interesting embodiment of the invention, the rod guide comprises a spring element that allows a pressure force to be exerted along the longitudinal direction of the rod guide, so that said rod guide is deformable between a compressed state and an extended state in its longitudinal direction.

In an interesting manner, said jaw displacer is at least partly made of a super elastic material, such as, for example, a nickel-titanium alloy. More specifically, said rod is preferably made of a super elastic material.

The invention is thus advantageously applied to influence the growth of a lower jaw in a patient with class II malocclusion before the lower jaw is fully grown.

Other details and advantages of the invention will become apparent from the following description of some specific embodiments of the jaw displacement system according to the invention. This description is given by way of example only and does not limit the scope of the claimed protection; the reference numbers used hereinafter refer to the appended figures.

FIG. 1 is a schematic side view of a lower jaw and the jaw joint, illustrating the effect of treatment with the jaw displacement system according to the invention.

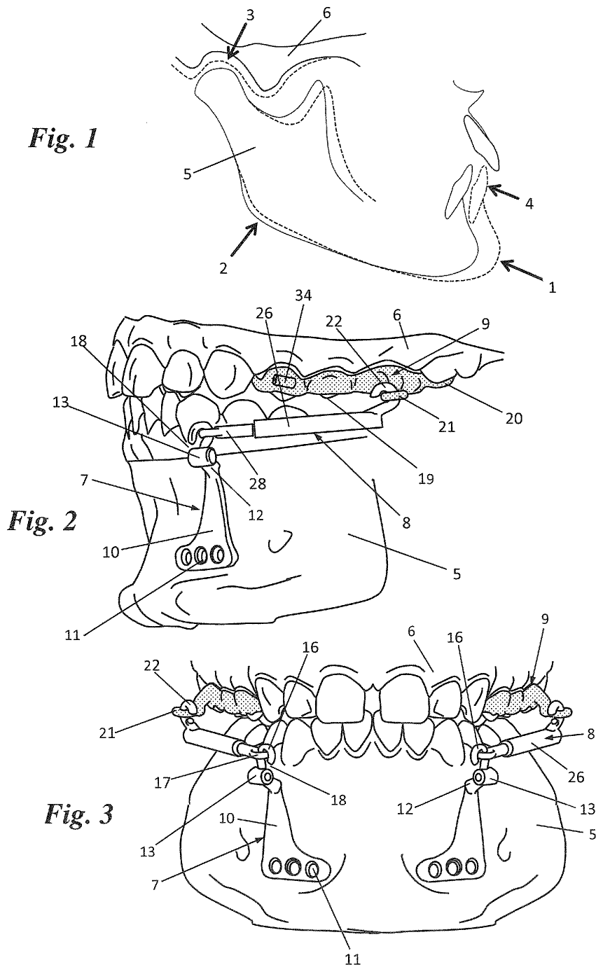

FIG. 2 is a schematic side view of a lower jaw and an upper jaw on which a jaw displacement system according to an interesting embodiment of the invention is mounted.

FIG. 3 is a schematic front view of the lower jaw and upper jaw with the jaw displacement system from FIG. 2.

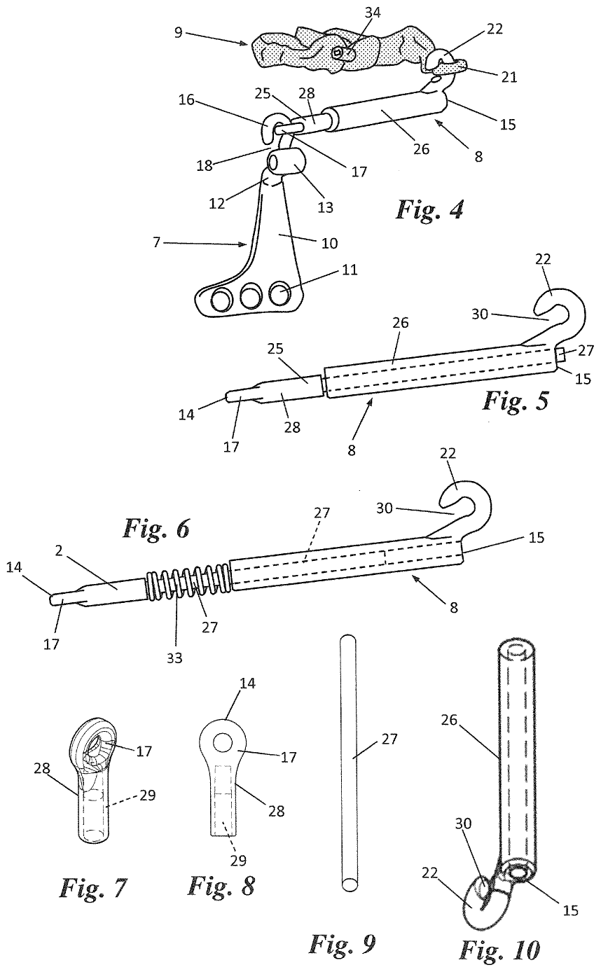

FIG. 4 is a schematic perspective view of a frame comprising a jaw displacer and a bone anchor of the jaw displacement system according to the invention.

FIG. 5 is a schematic side view of an interesting embodiment of a jaw displacer used in the jaw displacement system according to the invention.

FIG. 6 is a schematic side view of a variant of the jaw displacer in FIG. 5 that additionally includes a compression spring.

FIG. 7 is a schematic perspective view of an end piece of the jaw displacer forming a first end thereof.

FIG. 8 is a schematic front view of the end piece from FIG. 7.

FIG. 9 is a schematic perspective view of a rod for a jaw displacer according to the invention.

FIG. 10 is a schematic perspective view of a rod guide for a jaw displacer according to the invention.

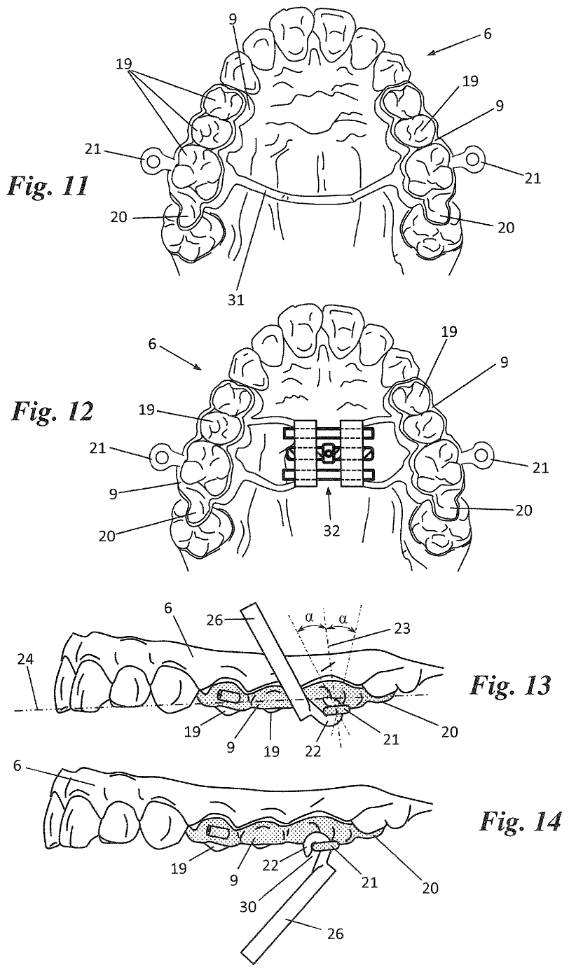

FIG. 11 is a schematic view of the palate of an upper jaw provided with a frame according to an advantageous embodiment of the jaw displacement system according to the invention.

FIG. 12 is a schematic view of the palate of an upper jaw provided with a frame according to a preferred embodiment of the jaw displacement system according to the invention.

FIG. 13 is a schematic side view of the upper jaw with the frame and rod guide from FIG. 2, in a mounting position of the rod guide.

FIG. 14 is a schematic side view of the upper jaw with the frame and rod guide from FIG. 2 when the rod guide is hanging freely in the oral cavity.

The jaw displacement system according to the invention allows a patient's lower jaw to be moved forward. When treating a patient with the system according to the invention, a number of very favourable changes are observed in the patient's jaws that do not occur simultaneously with the existing systems. Indeed, it appears that the existing systems mainly ensure a displacement of the teeth of the lower jaw relative to the jaw. However, when the jaw displacement system according to the invention is used, a number of significant changes are achieved in the lower jaw and the upper jaw. FIG. 1 schematically represents the shape of the jaws in full line before treatment with the jaw displacement system according to the invention is started, while the shape of the jaws after completion of the treatment is schematically represented by means of a dashed line.

Thus, applying the jaw displacement system according to the invention ensures that the lower jaw 5 is elongated in the ventral direction as indicated by reference number 1. In addition, it is observed that the shape of the lower jaw 5 changes because the gonial angle of the lower jaw 5 increases, as indicated by reference number 2. Furthermore, in the upper jaw 6, the shape and position of the glenoid fossa, also known as mandibular fossa, surprisingly also appears to have been altered. As schematically indicated by reference number 3, it has been moved slightly downward and forward by the treatment performed. A further advantage obtained by applying the invention is a retro-inclination of the incisors of the lower jaw 5 as indicated by reference number 4.

By applying the invention, it is thus possible to achieve a combination of these beneficial effects for correcting, for example, a class II malocclusion in a patient. Such results have not yet been achieved using existing non-surgical treatment methods for class II malocclusion.

FIGS. 2, 3 and 4 schematically show a first embodiment of the jaw displacement system according to the invention. This jaw displacement system allows a lower jaw 5 to be moved ventrally relative to an upper jaw 6.

To this end, the jaw displacement system includes at least a bone anchor 7, a jaw displacer 8 and a frame 9.

The bone anchor 7 has a fixation plate 10 that must fit onto the bone of the lower jaw 5 in order to secure the bone anchor 7 to the lower jaw 5. Through drill holes 11 in the fixation plate 10, the bone anchor is thus fixed firmly to the bone of the lower jaw 5 with screws. The fixation plate 10 fits onto a connecting element 12 that leads to a mounting member 13. Here, the fixation plate 10 must extend against the bone of the jaw 5 and under the gums, and the connecting element 12 must protrude through these gums so that the mounting member 13 extends into the oral cavity. The connecting element 12 preferably has a circular cross-section in order to ensure a good fit of the gums to this connecting element 12.

The jaw displacer 8 has an elongated shape and thus has two opposite ends 14 and 15. A first end 14 is provided with a fastening member for fastening the jaw displacer 8 directly to the mounting member 13 of the bone anchor 7. In the suggested embodiment, the mounting member 13 has a hook 16 to this end, while the fastening member is formed by an annular eye 17. When the bone anchor 7 is attached to the lower jaw 5, as shown in the figures, the opening 18 of the hook 16 is preferably turned away from the occlusal plane and is located mainly on the ventral side of the hook 16. This allows the jaw displacer 8 to be attached to the bone anchor 7 by sliding the annular eye 17 along the opening 18 from bottom to top over the hook 16, thus connecting them directly. The description from bottom to top means that the eye 17 is moved in a direction extending from the lower jaw 5 towards the upper jaw 6, almost transversely to a plane defined by the dental arch of the lower jaw 5.

The frame 9 of the jaw displacement system is provided to rigidly connect molars of the same quadrant of the upper jaw 6. Such a frame 9 is custom-made for each individual patient. To this end, an intra-oral scan of at least the molars of a patient's upper jaw is performed and, based on the data obtained from this scan, a frame is then digitally designed and manufactured for both quadrants of the upper jaw 6 by means of, for example, a so-called rapid-prototyping technique, such as selective laser melting (SLM).

It is of course also possible to manufacture such a frame 9 in a manner known as such, starting from a physical model of the upper jaw.

The frame 9 consists of a rigid structure that should connect laterally to the molars 19 of the upper jaw. It is usually preferred to rigidly connect the first premolar, the second premolar and the first molar of the same quadrant of the upper jaw 6 via this structure. The second molar is normally not surrounded on the distal side by the frame 9, as there is a risk of the frame on this side being overgrown by gums during the treatment.

However, to avoid level differences in the height of the chewing surfaces of the first and second molar due to the force exerted on the frame 9 by the jaw displacer 8 during the treatment, it may be interesting in some cases to provide an occlusal support 20 on the frame 9. This occlusal support 20 extends above the chewing surface of the second molar but should not necessarily rest on it so that the growth of this second molar is not hindered as long as it does not come in contact with the occlusal support 20.

The frame 9 has a fastening element for the second end 15 of the jaw displacer 8. Thus, this fastening element allows the second end 15 of the jaw displacer 8 to be directly connected to the frame 9.

This fastening element of the frame 9 is formed by a ring 21 and cooperates with a corresponding hook 22 provided for this purpose at the second end 15 of the jaw displacer 8. By attaching the hook 22 to the ring 21 by hooking it into this ring 21, the jaw displacer 8 is thus detachably connected to the frame 9.

The jaw displacer 8 generally comprises a rod 25 and a rod guide 26. Said first end 14 in this case forms part of the rod 25, whereas an end of the rod guide 26 forms said second end 15 of the jaw displacer 8 and is provided with said hook 22. The rod 25 can be moved in the longitudinal direction of the rod guide 26. By thus moving the rod 25 relative to the rod guide 26, the length of the jaw displacer 8 can be altered.

In the embodiments of the rod guide 26 represented in the figures, it is made hollow. More specifically, the rod guide 26 has a central cylindrical bore that is open on both sides and the rod 25 can be moved in its longitudinal direction through this cylindrical bore. The rod 25 in this case preferably comprises a cylindrical bar 27 which can be guided through the rod guide 26 in a fitting manner.

The rod 25 is provided with an end piece 28 shown, for example, in FIGS. 7 and 8. This end piece 28 is partly cylindrical and includes said annular eye 17 on one side and, on the opposite side, has an axial bore 29 in which the cylindrical bar 27 is clamped or secured in. Consequently, this cylindrical bar 27 has a diameter slightly smaller than that of the end piece 28. As a result, this end piece 28 forms a stop or a cushion for the rod guide 26 as it slides over the cylindrical bar 27 of the rod 25.

When the jaw displacement system is thus mounted with the bone anchor 7, the jaw displacer 8 and the frame 9 in the oral cavity of a patient on both sides of the jaw as shown in FIG. 3, it ensures that, when the mouth is closed, the lower jaw 5 is pushed forward relative to the upper jaw 6. More specifically, the dimensions of the rod guide 26 and of the end piece 28 of the rod 25 are selected such that the rod guide 26 will press against the end piece 28 when the mouth is closed. Consequently, in this position, a pressure force is applied between the bone anchor 7 and the frame 9 so that the lower jaw 5 is displaced ventrally relative to the upper jaw 6.

Furthermore, the length of the rod 25, more specifically of the cylindrical bar 27, is selected such that when the jaws 5 and 6 are moved into a normal open position of the mouth, the bar 27 will always partially extend into the rod guide 26 so that the jaw displacer 8 extends in one piece between the frame 9 and the mounting member 13 of the bone anchor 7.

The rod 25 and rod guide 26 of the jaw displacer 8 are non-flexible and, preferably, virtually incompressible in their longitudinal direction. Thus, a pressure force may be applied by the jaw displacer 8 between the bone anchor 7 and the frame 9 when the jaw displacer 8 is mounted in a patient's oral cavity. When this patient closes his/her mouth, the lower jaw is thus moved forward relative to the upper jaw as a result of the pressure force applied by the jaw displacer 8. The rod 25 and rod guide 26 can be made of, for example, titanium, a memory alloy, or a relatively rigid plastic. Thus, in order to allow the jaw displacer 8 to apply a pressure force in its longitudinal direction between the bone anchor 7 and the frame 9, it is crucial that the rod 25 and rod guide 26 are not flexible. In general, the jaw displacer is not flexible and allows a pressure force to be applied between its ends. A flexible material or object is defined as a material or object for which it is impossible to apply a pressure force between opposite ends thereof, as is the case, for example, for a rope, a rubber band, a strip of paper, and the like.

To remove the jaw displacer 8 from the oral cavity or to fit it in the oral cavity, the jaws 5 and 6 are opened wide. In this wide-open position of the mouth, the total length of the rod 25 and rod guide 26 is less than the distance between the mounting member 13 and the ring 21 of the frame 9.

FIG. 13 shows a mounting position of the rod guide 26. In this position, the longitudinal direction of the rod guide 26 is inclined upwards and extends partially above the frame 9, while the hook 22 remains connected to the frame 9 with the ring 21. In this mounting position, the opening 30 of the hook 22 is also directed towards the top of the frame 9 and away from the chewing surface of the teeth of the upper jaw 6. In order to thus remove the rod guide 26 from the hook 22, one merely has to move it downwards from the mounting position. In order to attach the rod guide 26 to the ring 21 on the frame 9, it is subjected to the same movement in reverse.

Once the rod guide 26 is thus connected to the frame 9 and the rod 25 to the bone anchor 7, as previously described, the jaws 5 and 6 are opened wide and the bar 27 is inserted into the bore in the rod guide 26 in order to assemble the jaw displacer 8. When closing the jaws again, the bar 27 slides through the rod guide 26 until it reaches said end piece 28. Upon reaching this end piece 28, the lower jaw 5 is forced forward.

FIG. 6 shows an alternative embodiment of the jaw displacer 8 according to the invention. Here, a compression spring 33 is arranged around the cylindrical bar 27, between the end piece 28 of the rod 25 and the rod guide 26. In the suggested embodiment, this compression spring 33 is formed by a helical spring that is coaxial with the rod 25. The presence of this compression spring 33 ensures, on the one hand, that when the jaws 5 and 6 close, the displacement of the rod guide 26 towards the end piece 28 is somewhat attenuated. Thus, when closing the jaws 5 and 6, the forces exerted on the frame 9 and on the bone anchor 7 are also attenuated and fewer impulse loads are applied on the latter. On the other hand, the presence of the compression spring 33 allows the pressure force exerted by the jaw displacer 8 on the bone anchor 7, and thus on the lower jaw 5, to be regulated as a function of the selected compression spring 33.

In order to avoid any plastic deformation of the jaw displacer 8 or, more specifically, the rod 25, when manipulating them, the jaw displacer 8 is preferably at least partially made of a super elastic material, in particular of, for example, a nickel-titanium alloy. Thus, the jaw displacer 8 automatically returns to its original shape after it has been intentionally or unintentionally deformed. Preferably, the rod 25 or the cylindrical bar 27 of this rod is made of such a super elastic metal. A super elastic material often has a relatively high elasticity but is not flexible.

Moreover, when it is preferred to manufacture the rod 25 or the bar 27 from a super elastic material, it is possible to select smaller diameters for these parts than when metals are used which are not super-elastic. Indeed, in the latter case, it must be ensured that the diameter of the parts is sufficiently large to avoid any plastic deformation, for example by folding or bending.

In order to prevent the hook 22 of the jaw displacer 8, more specifically of the rod guide 26, from being inadvertently or unintentionally removed from the ring 21 on the frame 9, the ring 21 is oriented such with respect to the frame 9 that the central axis 23 of the ring 21 has a maximum angle a of approximately 20°, preferably 15°, with respect to a perpendicular to the plane 24 of the dental arch of the upper jaw 6, as is schematically represented in FIG. 13. Preferably, it is ensured that the central axis 23 is virtually parallel to this perpendicular.

When the rod 25 is unintentionally or accidentally removed from the rod guide 26, the rod guide 26 will automatically assume a position as illustrated in FIG. 14 due to gravity, or due to the anatomical shape of the oral cavity. Here, the rod guide 26 extends mainly under the chewing surface of the upper jaw 6, or under the frame 9, and is directed towards the lower jaw 5. This ensures that the opening 30 of the hook 22 also faces the lower jaw so that the hook 22 cannot be removed from the ring 21. Indeed, to remove the hook 22, the rod guide 26 has to be manually put into said mounting position as described above and represented in FIG. 13.

FIG. 11 shows a variant of the embodiment of the frame 9 of the jaw displacement system according to the invention. Here, a respective frame 9 is placed on molars of each quadrant of the upper jaw 6, these frames 6 being connected by a rigid connecting rod 31.

FIG. 12 shows an extremely interesting embodiment of the frame 9 of the jaw displacement system according to the invention. Here, a frame 9 is provided on the molars in each of the quadrants of the upper jaw 6. These frames 9 are rigidly connected, opposite the palate, by a palatal expansion module 32. Such a module is known as such to the professional and is frequently used to widen a patient's upper jaw 6.

In the jaw displacement system according to the present invention, it is extremely interesting to provide such an expansion module 32 between the frames 9 of the upper jaw 6. Indeed, when moving the lower jaw 5 forward in relation to the upper jaw 6, as a result of the stimulated growth and change in shape of the lower jaw 5, the dental arch of the lower jaw will gradually move forward in relation to the dental arch of the upper jaw, as a result of which, during the patient's treatment, a crossbite would gradually occur.

By applying said palatal expansion module 32 during the treatment with the jaw displacer 8, it is possible, during the gradual forward displacement and growth of the lower jaw 5, to also gradually adjust the width of the upper jaw 6 as a function of the displacement of the lower jaw 5, such that the development of a crossbite is avoided.

It is also important to note that the use of an eye 17 or a ring 21 cooperating with a respective hook 16 or 22 of the connections at the ends 14 and 15 of the jaw displacer 8 allows the lower jaw 5 and the upper jaw 6 to undergo a lateral displacement relative to each other. Despite the presence of the jaw displacement system in the oral cavity, this allows the jaws 5 and 6 to be moved relative to each other in a comfortable manner during, for example, chewing motions.

In certain cases, it may be interesting to provide fastening means on the lateral side of the frame 9 to, for example, fix an orthodontic wire and thus also perform orthodontic treatment, together with the displacement of the lower jaw 5. More specifically, it is thus possible to orthodontically treat the incisors of the upper jaw in this way, for example. FIGS. 2 and 4 show such a fastening means in the form of a cylinder 34 having a bore with a rectangular section for an orthodontic wire.

1. A jaw displacement system for moving a lower jaw relative to an upper jaw, comprising:
at least one bone anchor comprising a fixation plate provided for fixing the bone anchor to the bone of the lower jaw, wherein said fixation plate is connected to a connecting element that leads to a mounting member and wherein the connecting element should protrude through the gums when the bone anchor is fixed to said bone so that the mounting member is located in the oral cavity, and
an elongated jaw displacer having two opposite ends, wherein a first end of these ends has a fastening member that allows the jaw displacer to be attached to said mounting member,
characterised in that the jaw displacement system comprises a frame provided for rigidly connecting molars of the same quadrant of the upper jaw, wherein the frame comprises a fastening element for a second end of said jaw displacer in order to connect said ends of the jaw displacer to, respectively, said mounting member and said fastening element to allow a pressure force to be applied between the frame and the bone anchor, in particular the mounting member, so as to ventrally move the lower jaw relative to the upper jaw when the frame is fixed to said molars and when the bone anchor, on the vestibular side, is fixed to the bone of the lower jaw.

2. The jaw displacement system according to claim 1, wherein said jaw displacer is not flexible and allows to apply a pressure force in its longitudinal direction between its two ends.

3. The jaw displacement system according to claim 1, wherein said fastening element forms a ring and cooperates with a corresponding hook provided for this purpose on said second end of the jaw displacer.

4. The jaw displacement system according to claim 3, wherein said ring is oriented such with respect to said frame to which it is connected, that the central axis of the ring has a maximal deviation of 20° with respect to a perpendicular to the plane defined by the dental arch of the upper jaw, wherein this central axis is preferably virtually parallel to this perpendicular.

5. The jaw displacement system according to claim 1, wherein said jaw displacer comprises a rod and a rod guide, wherein the rod connects to one of said ends of the jaw displacer and the rod guide connects to the opposite end of the jaw displacer, wherein the rod can be moved in the longitudinal direction of the rod guide relative to the latter.

6. The jaw displacement system according to claim 5, wherein said rod guide is made hollow with the first end being open to allow said rod to be moved and guided in its longitudinal direction in the rod guide.

7. The jaw displacement system according to claim 5, wherein said jaw displacer is made at least partly from a super elastic material, in particular from a nickel-titanium alloy.

8. The jaw displacement system according to claim 5, wherein said rod is made at least partly from a super elastic material, in particular from a nickel-titanium alloy.

9. The jaw displacement system according to claim 5, wherein said rod comprises an end piece forming said first end and a bar connecting to this end piece.

10. The jaw displacement system according to claim 9, wherein said bar is made of a super elastic material.

11. The jaw displacement system according to claim 1, wherein said frame forms a rigid whole.

12. The jaw displacement system according to claim 1, wherein said fastening element is provided on the frame in a position opposite the first molar and distally to this first molar when the frame is fixed to said molars.

13. The jaw displacement system according to claim 1, wherein said fastening element is provided on the frame in a position situated between the first and the second molar when the frame is fixed to said molars.

14. The jaw displacement system according to claim 1, wherein said frame has an occlusal support which should extend at least partially opposite the chewing surface of the second molar when the frame is fixed to said molars.

15. The jaw displacement system according to claim 1, wherein said fastening element extends buccally to the frame opposite said molars when the frame is fixed to these molars.

16. The jaw displacement system according to claim 1, wherein said frame is provided for each of both quadrants of the upper jaw, wherein both frames are rigidly connected to each other.

17. The jaw displacement system according to claim 1, wherein said frame is provided for each of both quadrants of the upper jaw, wherein these frames are connected by a palatal expansion module which is to extend opposite the palate.

18. The jaw displacement system according to claim 1, wherein said frame is provided to be attached to said molars wherein it at least partially encloses each of these molars.

19. The jaw displacement system according to claim 1, wherein the jaw displacer comprises a spring element allowing to apply a pressure force between said ends.

20. The jaw displacement system according to claim 1 for influencing the growth of a patient's lower jaw having a class II malocclusion before the lower jaw is fully grown.
